(19) United States
(12) Patent Application Publication
(10) Pub. No.: US 2014/0196656 A1
(43) Pub. Date: Jul. 17, 2014

(54) RESCUE BOAT

(71) Applicant: TAN VIEN DONG CO. LTD., Ho Chi Minh City (VN)

(72) Inventor: Bui Van Cong, Ho Chi Minh City (VN)

(73) Assignee: Tan Vien Dong Co. Ltd., Ho Chi Minh City (VN)

(21) Appl. No.: 13/740,096

(22) Filed: Jan. 11, 2013

(51) Int. Cl. B63C 9/02; B23P 11/00

(52) U.S. Cl. CPC B63C 9/02; B23P 11/00
USPC 114/348; 156/60; 156/92; 29/428; 29/464; 29/525.01; 29/525.11

(57) ABSTRACT

Embodiments of a rescue boat are disclosed. A rescue boat can include a port pontoon, a starboard pontoon, and a deck, the deck being attachable to the port pontoon and the starboard pontoon. A method of launching the rescue boat includes placing a port pontoon, a starboard pontoon, and a deck in proximity close to a launch point; mating the deck with the port pontoon and the starboard pontoon; attaching the deck with the port pontoon and the starboard pontoon; mounting a motor on a motor mount on the deck; and launching the rescue boat formed by the port pontoon, the deck, and the starboard pontoon.

### TECHNICAL FIELD

Embodiments of the present invention are directed to embodiments of a Rescue Boat.

### DISCUSSION OF RELATED ART

Rescue boats are utilized in various rescue applications. Rescue boats can be utilized to rescue victims during a flood or to search and assist victims of a boating accident or other disaster that involves water access. Current types of rescue boats, for example, include inflatable boats. However, inflatable boats often leak air and may not be serviceable during an emergency as needed. Further, obstructions and debris in the water can rip open the boat, resulting in significant risk to both rescuers and the victims that they are trying to rescue. Additionally, such boats may be hard to handle in fast waters such as may occur during a flood or rescues on a river.

Other types of rescue boats include aluminum dinghies and similar boats. Instability of these boats can result in significant risk for both the rescuers and the victims, especially while attempting to pull victims onboard.

Additionally, both types of boats are difficult to deploy during emergencies where rescue operations are in remote areas, without direct road access. These types of boats are typically transported on trailers or, on occasion, can be loaded into trucks. However, they tend to be heavy and difficult to manage for a small number of rescuers. These boats, especially those that are trailered, can be difficult to launch in the unstable circumstances that may occur during a rescue attempt.

Therefore, there is a need for better, more stable, and easier to handle rescue boats.

### SUMMARY

In accordance with aspects of the present invention, a rescue boat is presented. In some embodiments, a rescue boat includes a port pontoon, a starboard pontoon, and a deck, the deck being attachable to the port pontoon and the starboard pontoon.

A method of launching a rescue boat according to some embodiments of the present invention includes placing a port pontoon, a starboard pontoon, and a deck in proximity close to a launch point; mating the deck with the port pontoon and the starboard pontoon; attaching the deck with the port pontoon and the starboard pontoon; mounting a motor on a motor mount on the deck; and launching the rescue boat formed by the port pontoon, the deck, and the starboard pontoon.

These and other embodiments are further discussed below with respect to the following figures.

### BRIEF DESCRIPTION OF THE DRAWINGS

FIGS. 1A and 1B illustrate a rescue boat according to some embodiments of the present invention.

FIG. 2A illustrates a plan view of an assembled rescue boat according to some embodiments of the present invention.

FIG. 2B illustrates a starboard-side view of the assembled rescue boat illustrated in FIG. 2A

FIG. 2C shows a bow view of the assembled rescue boat illustrated in FIG. 2A.

FIG. 2D shows an aft view of the assembled rescue boat illustrated in FIG. 2A.

FIG. 2E shows a transom view of the assembled rescue boat illustrated in FIG. 2A.

FIG. 2F illustrates a forward looking cross section of the assembled rescue boat at the position S1 shown in FIG. 2A.

FIG. 2G illustrates a forward-looking cross section of the assembled rescue boat at the position S2 shown in FIG. 2A

FIG. 2H illustrates a forward-looking cross section of the assembled rescue boat at the position S3 shown in FIG. 2A.

FIG. 2I illustrates drainage of an assembled rescue boat according to some embodiments of the present invention.

FIGS. 3A, 3B, and 3C illustrate a side view, bottom view, and back view, respectively, of an embodiment of the center hull of a rescue boat according to some embodiments of the present invention.

FIG. 4A illustrates assembly of a rescue boat according to some embodiments of the present invention.

FIG. 4B illustrates placement of a deck on port and starboard pontoons according to some embodiments of the present invention.

FIG. 4C illustrates a side view of mating mounts utilized to fix the deck to the pontoons according to some embodiments of the present invention.

FIG. 4D illustrate another view of mating mounts utilized to fix the deck to the pontoons according to some embodiments of the present invention.

FIG. 5 illustrates further features of a rescue boat according to some embodiments of the present invention.

FIG. 6A illustrates formation and bonding of seats according to some embodiments of the present invention.

FIG. 6B illustrates formation of mating mounts according to some embodiments of the present invention.

FIG. 6C illustrates formation of a transom according to some embodiments of the present invention.

FIG. 6D illustrates a side view of the transom illustrated in FIG. 6C.

FIG. 7A illustrates formation of a rescue ramp on a rescue boat according to some embodiments of the present invention.

FIGS. 7B, 7C, and 7D, illustrates formation of an embodiment of a mount utilized in the rescue ramp shown in FIG. 7A.

FIGS. 7E and 7F illustrate construction and formation of a hinge utilized in the rescue ramp shown in FIG. 7A.

In the figures, elements provided with the same element number have the same or similar function.

### DETAILED DESCRIPTION

Some embodiments of the present invention provide for a rescue boat that is easily transported by a minimum (e.g. two) number of rescuers. The ability to transport a rescue boat according to some embodiments manually by as few as two rescuers allows for the rescue boat to be easily deployed anywhere. In addition, the dismantled components of some rescue boats according to embodiments of the present invention maximizes space utilization for both storage and for transport on trucks or other vehicles. The ability to easily store and transport rescue boats is important for large scale rescue operations undertaken during major disasters.

In the following description, specific details are set forth describing some embodiments of the present invention. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure.

This description and the accompanying drawings that illustrate inventive aspects and embodiments should not be taken as limiting—the claims define the protected invention. Various mechanical, compositional, structural, and operational changes may be made without departing from the spirit and scope of this description and the claims. In some instances, well-known structures and techniques have not been shown or described in detail in order not to obscure the invention.

Additionally, the drawings are not to scale. Relative sizes of components are for illustrative purposes only and do not reflect the actual sizes that may occur in any actual embodiment of the invention. Like numbers in two or more figures represent the same or similar elements.

Further, this description's terminology is not intended to limit the invention. For example, spatially relative terms—such as “beneath”, “below”, “lower”, “above”, “upper”, “proximal”, “distal”, and the like—may be used to describe one element's or feature's relationship to another element or feature as illustrated in the figures. These spatially relative terms are intended to encompass different positions (i.e., locations) and orientations (i.e., rotational placements) of a device in use or operation in addition to the position and orientation shown in the figures. For example, if a device in the figures is turned over, elements described as “below” or “beneath” other elements or features would then be “above” or “over” the other elements or features. Thus, the exemplary term “below” can encompass both positions and orientations of above and below. A device may be otherwise oriented (rotated 90 degrees or at other orientations) and the spatially relative descriptors used herein interpreted accordingly. Likewise, descriptions of movement along and around various axes includes various special device positions and orientations. In addition, the singular forms “a”, “an”, and “the” are intended to include the plural forms as well, unless the context indicates otherwise. And, the terms “comprises”, “comprising”, “includes”, and the like specify the presence of stated features, steps, operations, elements, and/or components but do not preclude the presence or addition of one or more other features, steps, operations, elements, components, and/or groups. Components described as coupled may be mechanically directly coupled, or they may be indirectly coupled via one or more intermediate components.

Elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

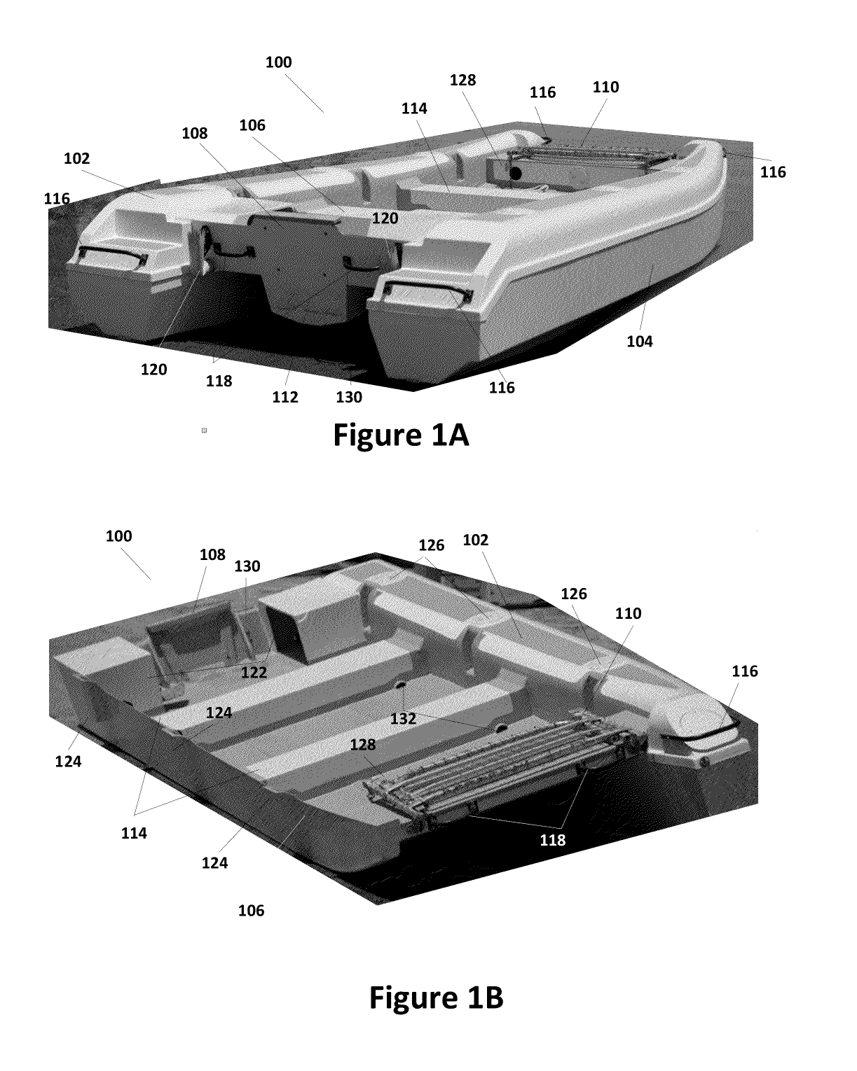

FIG. 1A illustrates an assembled rescue boat 100 according to some embodiments of the present invention. Rescue boat 100 includes three separable parts, including a port pontoon 102, a starboard pontoon 104, and a deck 106. Port pontoon 102 and starboard pontoon 104 are hard hulls that provide floatation, stability, and maneuverability to assembled rescue boat 100. Deck 106 can include an integrally formed center hull 112 that allows for greater stability and handling in the water. Deck 106 can also include an integrally formed transom 130 that includes a motor mount 108 for holding a motor. As such, transom 130 with integrally formed motor mount 108 are structurally capable of providing forward thrust from a motor (not shown) to assembled rescue boat 100.

In some embodiments, assembled rescue boat 100 provides for a virtually unsinkable structure. Additionally, some embodiments of rescue boat 100 are highly stable, allowing for ease of use during rescue operations. Embodiments of rescue boat 100 according to the present invention can be virtually impossible to capsize because of pontoons 102 and 104. Embodiments of rescue boat 100 can be easily storable, transportable and deployable by a minimum number of people due to the ease of assembly and disassembly. Further, some embodiments of rescue boat 100 can be highly maneuverable. Further, embodiments of rescue boat 100 can have hard-constructed pontoons 102 and 104 and deck 106 that provide for high durability and toughness under rescue conditions. Pontoons 102 and 104 are not easily damaged by collisions with underwater obstructions or by rough handling during transport and launch. This combination of features exhibited by some embodiments of rescue boat 100 can provide for fast rescues under extreme conditions.

As is shown in FIG. 1A, seats 114 and a forward platform 128 can be integrally formed with deck 106. Seats 114 and platform 128 can be constructed to provide structural enforcement as well as for the convenience of rescuers and victims. Further, a rescue ramp 110 can be mounted to deck 106 at forward platform 128. Rescue ramp 110 can fold out from the bow of rescue boat 100 and lay in the water in to facilitate boarding of victims onto rescue boat 100 when deployed. In some embodiments, rescue ramp 110 can be folded and stored on top of platform 128.

As shown in FIG. 1A, port pontoon 102 and starboard pontoon 104 can include handles 116 and deck 108 can include handles 118. Handles 116 are positioned fore and aft on port pontoon 102 and starboard pontoon 104 to allow easy carrying of each of port pontoon 102 and starboard pontoon 104. Similarly, handles 118 are positioned on deck 108 to allow for easy carrying of deck 108.

FIG. 1B illustrates another view of rescue boat 100. For illustration purposes, starboard pontoon 104 is removed in FIG. 1B. As shown in FIG. 1B, seats 114 can include drainage passages 132 that allows water to flow to scuppers 120 formed in transom 130 of deck 102. Further, mating mounts 124 are integrally formed in deck 102 to allow for mounting of pontoons 102 and 104 with deck 102. Further, access hatches 126 formed in pontoons 102 and 104 can provide access to mounting hardware at mating mounts 124 and access to various portions of pontoons 102 and 104. As is shown in FIGS. 1A and 1B, storage lockers 122 may also be integrally formed in deck 102 to provide further seating and storage for equipment such as rescue gear, flotation devices, first aid gear, or other equipment. In some embodiments, storage lockers 122 can include one or more fuel tanks.

As is illustrated in FIGS. 1A and 1B, the three parts of rescue boat 100—deck 102, port pontoon 102, and starboard pontoon 104 can be assembled very quickly by a minimum number of rescuers, for example two rescuers. The disassembled rescue boat 100 can be easily loaded into a vehicle, easily stored and can be easily handled and launched wherever needed during a rescue operation. Rescue boat 100 does not require access to a launch ramp or other launching facilities to facilitate launching. Rescue boat 100 can be quickly assembled and launched under a wide range of emergency conditions, and in particular anywhere that is accessible to the rescuers.

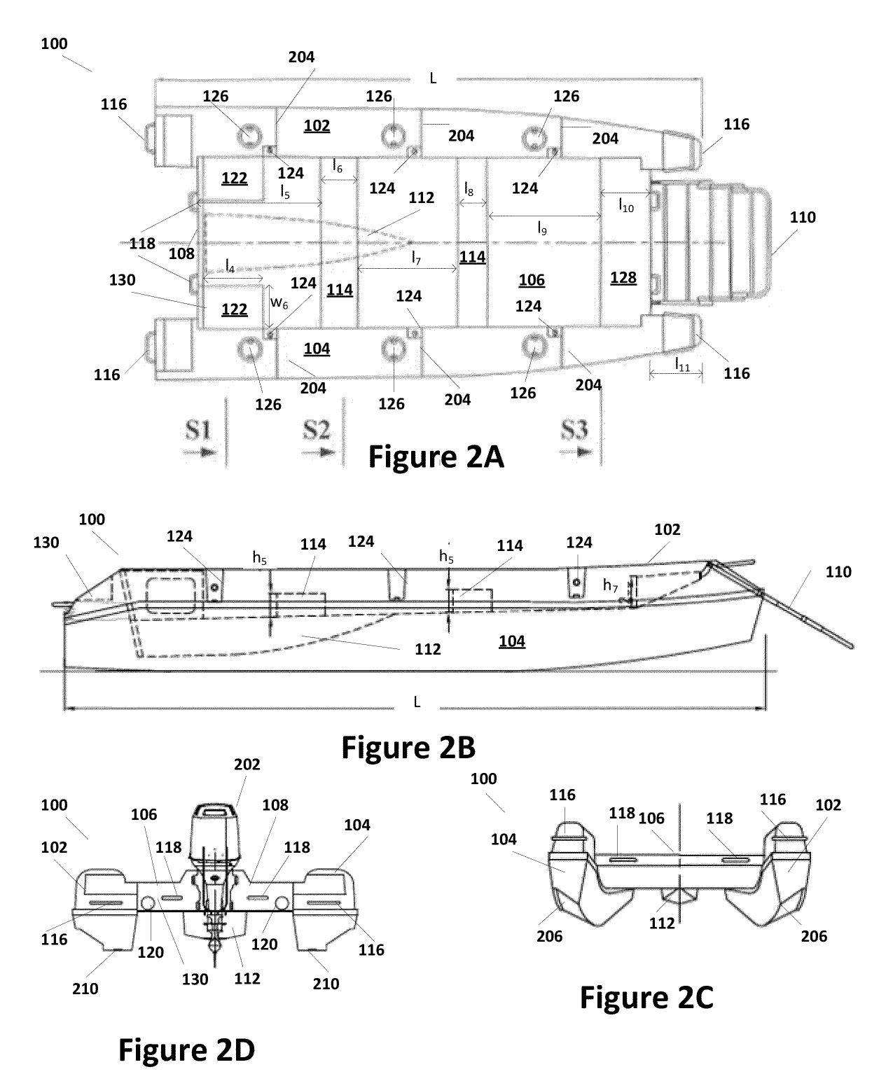

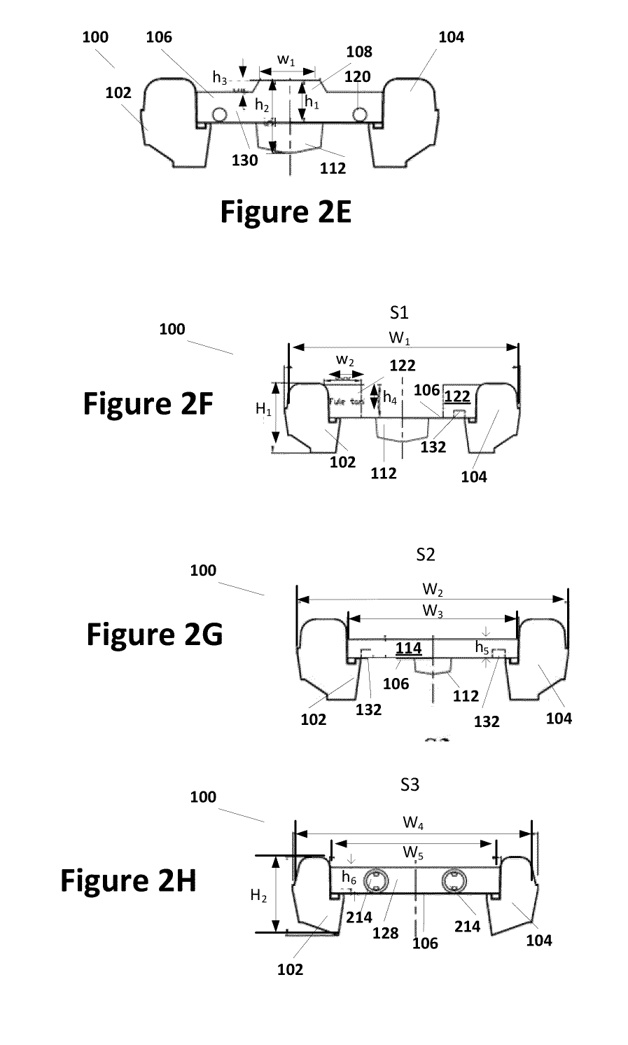

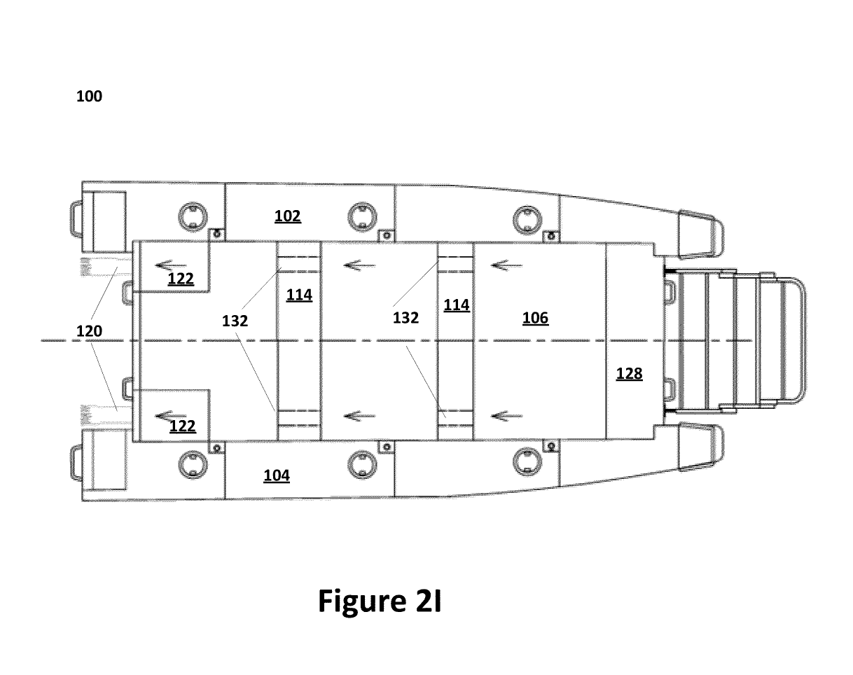

FIG. 2A illustrates a plan view of assembled rescue boat 100 according to some embodiments of the present invention. As shown in FIG. 2A, port side pontoon 102 and starboard side pontoon 104 are mechanically attached to deck 106 at mating mounts 124. In the example shown in FIG. 2A, there are three mating mounts 124 illustrated between port side pontoon 102 and deck 106 and a corresponding three mating mounts 124 between starboard side pontoon 104 and the opposite side of deck 106. Each of port-side pontoon 102 and starboard-side pontoon 104 includes access hatches 126 proximate to mating mounts 124 for inspection purposes, in case of water ingress into pontoon compartment that may result from a collision or other damage.

Further, as illustrated in FIG. 2A, pontoons 102 and 104 may also include integrally formed supports 204. In some embodiments, supports 204 can be water-tight walls formed to fit within pontoons 102 and 104, forming multiple compartments separated by walls. As such, supports 204 may be structural supports or may be water-tight bulkheads. Multiple compartments in each of pontoons 102 and 104 can provide further safety to rescue boat 100 if one of pontoons 102 and 104 are damaged during operation.

As shown in FIG. 2A, rescue ramp 110, which is shown deployed, can be mounted on platform 128. In some embodiments, rescue ramp 110 can be folded and stowed on platform 128. FIG. 2A further illustrates center hull 112, which is an integrally formed portion of deck 106.

As is shown in FIG. 2A, the overall length of assembled rescue boat 100 is the length L of pontoons 102 and 104, each of which are of the same length and symmetrically formed with respect to each other. As is further illustrated in FIG. 2A, pontoons 102 and 104 can be slightly towed in to provide better stability and control of rescue boat 100, especially under high current conditions.

FIG. 2A also illustrates dimensions related to deck 106. As shown in FIG. 2A, storage locker has a length of l₄ and a width of w₆. The length between transom 130 and an aft seat 114 is l₅. The width of aft seat 114 is l₆. The length between seats 114 is l₇. The width of fore seat 114 is l₈. The length between fore seat 114 and platform 128 is l₉ and the width of platform 128 is l₁₀. The total length of deck 106, therefore, is l₄+l₅+l₆+l₇+l₈+l₉+l₁₀. In some embodiments, when deck 106 is mounted on pontoons 102 and 104, pontoons 102 and 104 may extend a length l₁₁ from the edge of platform 128.

FIG. 2B illustrates a view of the starboard side of rescue boat 100. As such, the general shape of center hull 112 is illustrated. As is shown between FIGS. 2A and 2B, center hull 112 is relatively wide and deep at transom 130. As illustrated in FIG. 2A, center hull 112 tapers to a point away from transom 130 towards the bow of rescue boat 100. As shown in FIG. 2B, center hull 112 is sloped to a point away from transom 130. As such, center hull 112 can be a V shaped hull that can stabilize rescue boat 100 by providing a keel and additional flotation on the stern of assembled rescue boat 100. As is further shown in FIG. 2B, center hull 112 may be formed such that it is shallower than pontoons 102 and 104.

As is further shown in FIG. 2B, seats 114 can have a height of h₅ from deck 106. Further, the forward portion of pontoons 102 and 104 are sloped to form forward sections. Height h₇ is the height of the slope shown.

FIG. 2C illustrates a bow view of rescue boat 100 illustrated in FIGS. 2A and 2B. As illustrated in FIG. 2C, pontoons 102 and 104 are formed such that surfaces 206 on each of pontoons 102 and 104 are angled to cut through water in a controlled way and provide stability to the handling of rescue boat 100. FIG. 2C further illustrates the forward shape of center hull 112. Center hull 112 can provide upward lift for rescue boat 100 during operation. Surfaces 206 can also provide upward lift for rescue boat 100 during operation.

FIG. 2D illustrates an aft view of assembled rescue boat 100. As shown in FIG. 2D, the bottom of center hull 112 is above the bottom of pontoons 102 and 104. As is further shown in FIG. 2D, a motor 202 is mounted on motor mount 108 of transom 130. Motor 202 can be any sized and type of outboard motor. Motor 202 can be sized appropriately for rescue boat 100. As is further shown in FIG. 2D, scuppers 120 are formed in transom 130. Further, each of pontoons 102 and 104 can include a skid 210. Skid 210 can protect the bottom of pontoons 102 and 104 as rescue boat 100 is dragged across rough surfaces. In some embodiments, skid 210 can include strips that can be replaced as they wear.

FIG. 2E illustrates a view of transom 130. As shown in FIG. 2E, motor mount 108 has a width w₁. The top of motor mount 108 is a height h₃ above the top of transom 130, which has a height h₁. The distance between the top of motor mount 108 and the bottom of center hull 112 is h₂.

FIG. 2F illustrates a cross-sectional view of rescue boat 100 at the position labeled S1 in FIG. 2A, viewed in a forward direction. FIG. 2F illustrates a cross section through storage lockers 122. As shown in FIG. 2F, storage lockers 122 can have a width w₂ and a height h₄. As is further illustrated in FIG. 2F, rescue boat 100 has an overall width of W₁ at point S1 and pontoons 102 and 104 have an overall height of H₁ at point S1. FIG. 2F also illustrates drainage passages 132 that direct water to scuppers 120.

FIG. 2G illustrates a cross-sectional view of rescue boat 100 at the position labeled S2 in FIG. 2A, viewed in a forward direction. The cross-sectional view illustrated in FIG. 2G is through one of seats 114. As shown in FIG. 2G, the overall width of rescue boat 100 is W₂ and the inner width of rescue boat (the width between the inner surfaces of pontoons 102 and 104) is W₃. As is further shown in FIG. 2G, the height of seats 114 is h₅. FIG. 2G also illustrates drainage passages 132 that direct water to scuppers 120.

FIG. 2H illustrates a cross-sectional view of rescue boat 100 at the position labeled S3 in FIG. 2A, viewed in a forward direction. The cross-sectional view illustrated in FIG. 2H is through platform 128. As shown in FIG. 2H, the overall width of rescue boat 100 at point S₃ is W₄ while the inner width of rescue boat 100 at point S3 is W₅. The height of platform 128 is h₆. The height of pontoons 102 and 104 at point S3 is H₂. As shown in FIG. 2H, platform 128 may include one or more access hatches 214 that allow inspection of the volume within platform 128.

FIG. 2I illustrates drainage of rescue boat 100. As shown in FIG. 2I, any water on deck 106 flows through drainage passages and out scuppers 120. Drainage passages 132 can be formed in seats 114 and in storage compartments 122.

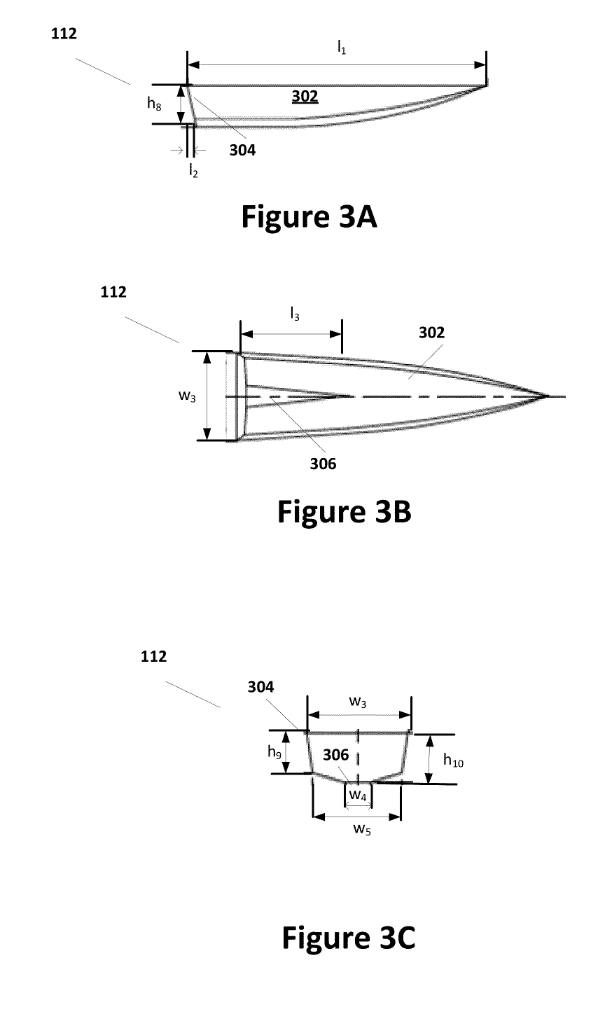

FIGS. 3A, 3B, and 3C illustrate an embodiment of center hull 112. FIG. 3A illustrates a starboard-side view of center hull 112. Center hull 112 includes a body 302 that is sloped to a V shape forward and a transom portion 304. Transom portion 304 aligns with transom 130, and is attached to transom 130, of deck 106. In some embodiments, center hull 112 is integrally formed with deck 106.

As shown in FIG. 3A, the length of body 302 is l₁. Transom portion 304 has a height of h₈. Transom 304 is sloped in so that the bottom of body 302 is a length l₂ shorter than the l₁ length of the top of body 302.

FIG. 3B illustrates a view of center hull 112 viewed from below. As shown in FIG. 3B, body 302 of center hull 112 includes a flat portion 306. Flat portion 306 is V shaped due to the V-shape of center hull 112 itself and has a length l₃. As is further shown in FIG. 3B, the width of body 302 is w₃.

FIG. 3C illustrates an aft view of center hull 112. As shown in FIG. 3C, flat portion 306 has a width of w₄. As is shown in FIG. 3C, body 306 is slightly V shaped for a height of h₉ from the top of transom portion 304 and more drastically V-shaped to flat portion 306. The width of the more drastic V-shaped portion is w₅. The height between the top of transom portion 304 and flat portion 306 is h₁₀.

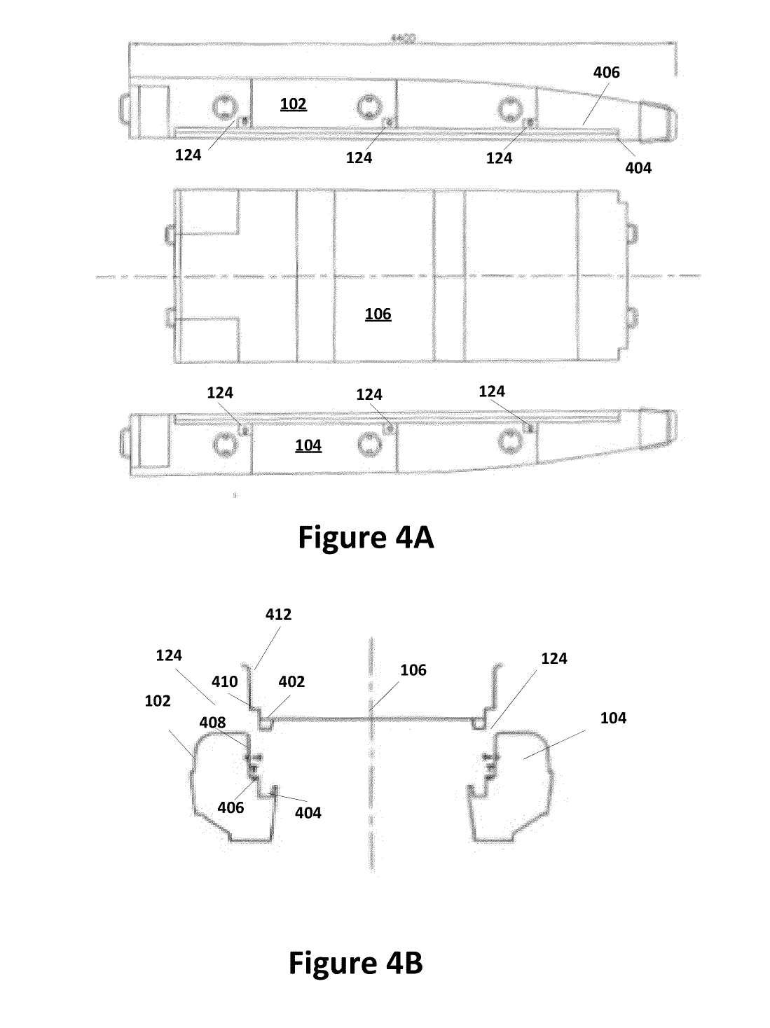

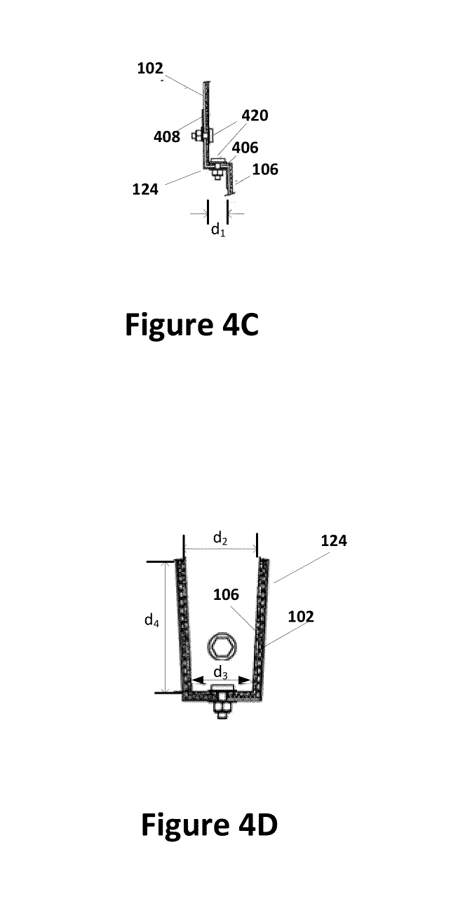

FIGS. 4A, 4B, 4C, and 4D illustrate the formation of mating mounts 124. FIG. 4A illustrates the separated pontoons 102 and 104 and deck 106. Mating mounts 124 are shown in pontoons 102 and 104. Further, inset 404 and shelf 406 are illustrated on pontoon 102. Inset 404 and shelf 406 run the length of deck 106 along pontoons 102 and 104.

FIG. 4B illustrates an example of the mating of deck 406 with pontoons 102 and 104 at one pair of mating mounts 124. As shown in FIG. 4B, inset 404 formed in pontoons 102 and 104 receives guides 402 formed on deck 106. Meanwhile shelf 406 receives lip 410 formed on deck 106. Mating mounts 124 are partially formed in wall 408 of pontoons 102 and 104.

FIG. 4C shows a cross section of mating mounts 124. As shown in FIG. 4C, shelf 406 has a width of d1. Bolts 420 fix deck 106 to pontoons 102. FIG. 4D shows a view of mating mounts 124. As shown in FIG. 4D, mating mounts 124 has a width of d₂ at the top and d₃ at the bottom and height d₄.

FIGS. 4A and 4B further illustrate assembly of rescue boat 100. A method of launching rescue boat 100 includes placing port pontoon 102, starboard pontoon 104, and deck 106 in proximity close to a launch point. FIG. 4A illustrates port pontoon 102, starboard pontoon 104, and deck 106 placed in proximity to one another. Deck 106 can then be mated with port pontoon 102 and starboard pontoon as illustrated in FIG. 4B. As shown in FIG. 4B, guides 402 are aligned with insets 404 to couple deck 106 with pontoons 102 and 104. Deck 106 can then be fixedly attached to deck 102 and 104 utilizing a fastener as illustrated in FIGS. 4C and 4D. Once assembled, a motor 202 can be mounted on motor mount 108 on transom 130. Rescue boat 100 can then be launched.

Deck 106 can be fixed to port pontoon 102 and starboard pontoon 104 by installing and tightening bolts 420 as shown in FIGS. 4C and 4D. Although the example of rescue boat illustrated in FIGS. 4A, 4B, 4C, and 4D utilizes bolts to fix deck 106 to port pontoon 102 and starboard pontoon 104, other suitable fasteners that provide sufficient strength can be utilized.

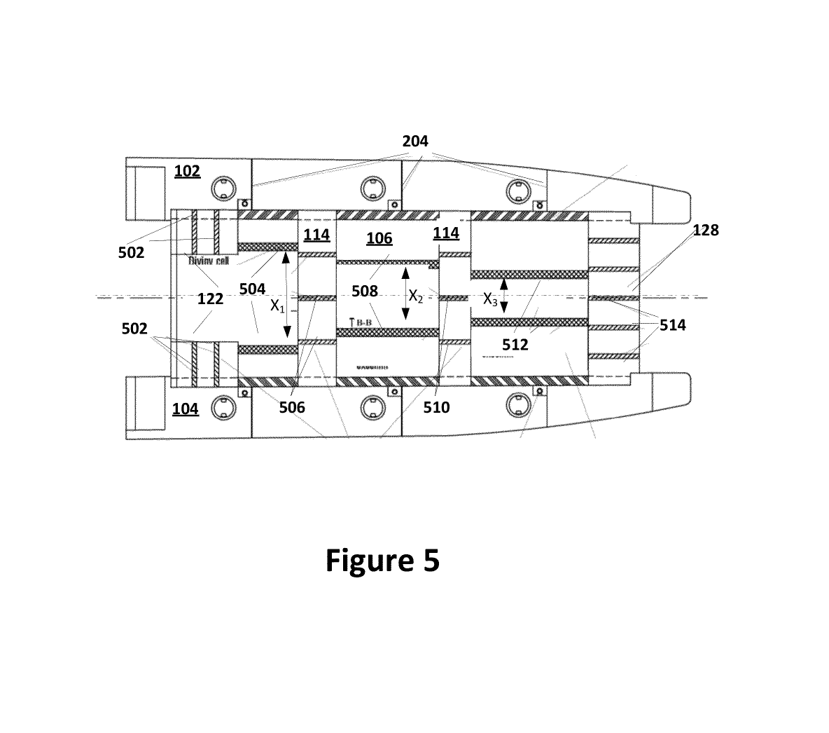

FIG. 5 provides further details of sections of aspects of rescue boat 100. Walls 204 shown in FIG. 5 can be formed of fibre reinforced plastic (FRP). FIG. 5 also illustrates drainage passages 502 formed in storage compartments 122, drainage passages 506 formed in aft seats 114, drainage passages 510 formed in forward seat 114, and drainage passages 514 formed in platform 128. Drainage passages 502, 506, 510, and 514 can be formed utilizing half sections of PVC pipe (½-PVC pipe).

FIG. 5 further shows structural reinforcement members 504 positioned in an aft portion of deck 106, structural reinforcement members 508 positioned in a center section of deck 106, and structure reinforcement members 512 formed in a forward portion of deck 106. Structural reinforcement members 504, 508, and 512 can be Divinycells, which are foam-core polymer structural materials. As shown in FIG. 5, reinforcement members 504 are centered on the center line of deck 106 and separated by a distance S₁; reinforcement members 508 are centered on the center line of deck 106 and separated by a distance X₂; and reinforcement members 512 are centered on the center line of deck 106 and separated by a distance X₃.

The dimensions of an exemplary embodiment of rescue boat 100 are provided in the following table. In this example, rescue boat 100 has an overall length of 4.4 meters, the overall length L of pontoons 102 and 104. Deck 106 has a length of 3.6 meters. The overall width is 2.2 meters. The depth is 0.65 meters. In this example, deck 106 is centered on pontoons 102 and 104 such that 0.4 meters of pontoon extends beyond deck 106 both fore and aft. One skilled in the art will recognize that embodiments of rescue boat 100 can utilize other sets of dimensions. Drainage passages 502, 506, 510, and 514 can be formed of ½-PVC pipe with a pipe diameter of 34 mm. Structural reinforcement members 504, 508, and 512 can be Divinycells of dimensions 8×60 mm and of a length to span the appropriate sections of deck 106. Walls 204 are formed of FRP of dimensions 3×70 mm and shaped to fit within pontoons 102 and 104. The bolts utilized to mount pontoons 102 and 104 to deck 106 can be stainless-steel 12 mm bolts.

TABLE 1

| Designation | Value (mm) |
|---|---|
| L | 4400 |
| h₁ | 310 |
| h₂ | 535 |
| h₃ | 90 |
| h₄ | 300 |
| h₅ | 150 |
| h₆ | 200 |
| h₇ | 200 |
| h₈ | 228 |
| h₉ | 185 |
| h₁₀ | 228 |
| w₁ | 440 |
| w₂ | 350 |
| w₃ | 470 |
| w₄ | 115 |
| w₅ | 415 |
| w₆ | 350 |
| W₁ | 2190 |
| W₂ | 2170 |
| W₃ | 1370 |
| W₄ | 1909 |
| W₅ | 1330 |
| H₁ | 650 |
| H₂ | 600 |
| l₁ | 1670 |
| l₂ | 55 |
| l₃ | 550 |
| l₄ | 520 |
| l₅ | 990 |
| l₆ | 300 |
| l₇ | 800 |
| l₈ | 250 |
| l₉ | 910 |
| l₁₀ | 400 |
| l₁₁ | 400 |
| d₁ | 55 |
| d₂ | 110 |
| d₃ | 90 |
| d₄ | 200 |
| X₁ | 800 |
| X₂ | 530 |
| X₃ | 370 |

Rescue boat 100 can be constructed with standard building materials and construction techniques. Materials can include Gelcoat, Chopped Strand Fiberglass Mat (CSM), Fiberglass Multiaxial Fabric (E-glass stitch combo mat either E-BX or E-BXM with +45° and −45 directions), fibre matrix materials (MAT), Divinycells, polyvinyl chloride (PVC), fibre reinforced plastic (FRP), laminated glass panels (RW), and plywood. Deck 106 can be formed with the following lamination schedule: Gelcoat, CSM 300 (300 g/mm²), CSM 300, E-BX600 (600 g/mm²), CSM 300, Diviny cell (8×60 mm), CSM 300, and CSM 300.

Platform 128 can be formed with the following lamination schedule: Gelcoat, CSM 300, E-BXM 450/225, MAT 300 and ½-PVC with diameter 34 mm covered by CSM 300, CSM 300. Seats 114 can be formed with the following lamination schedule: Gelcoat, CSM 300, E-BXM 450/225, CSM 300, ½-PVC at 34 mm diameter covered by CSM 300, and CSM 300.

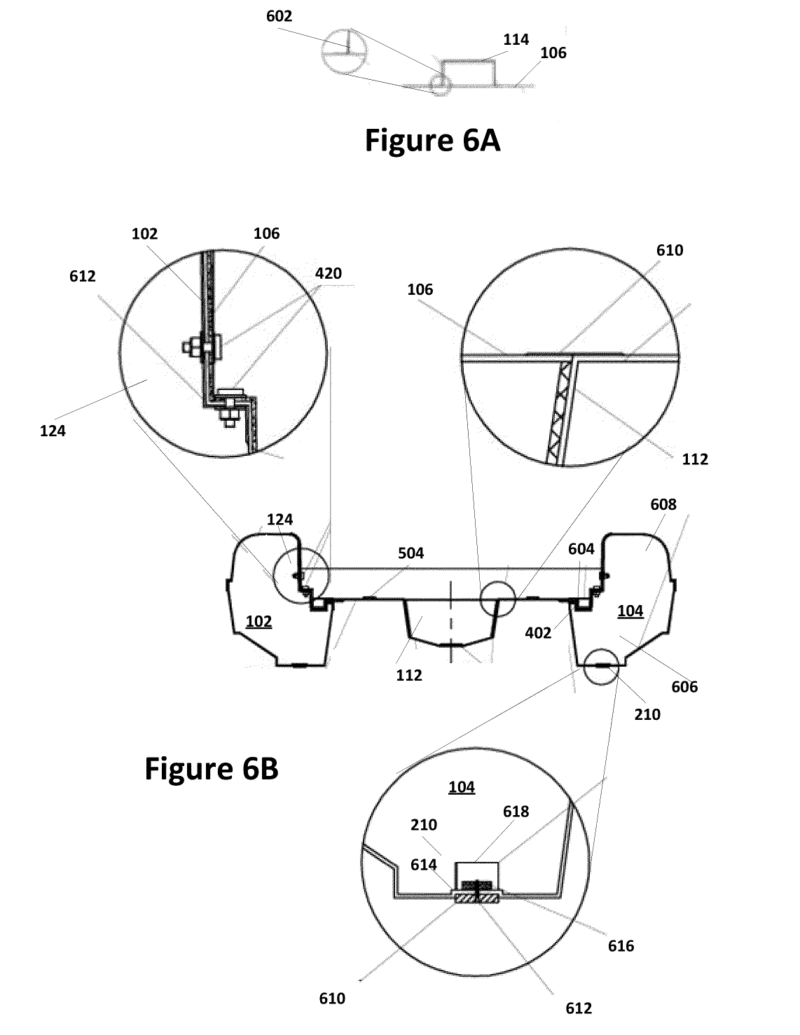

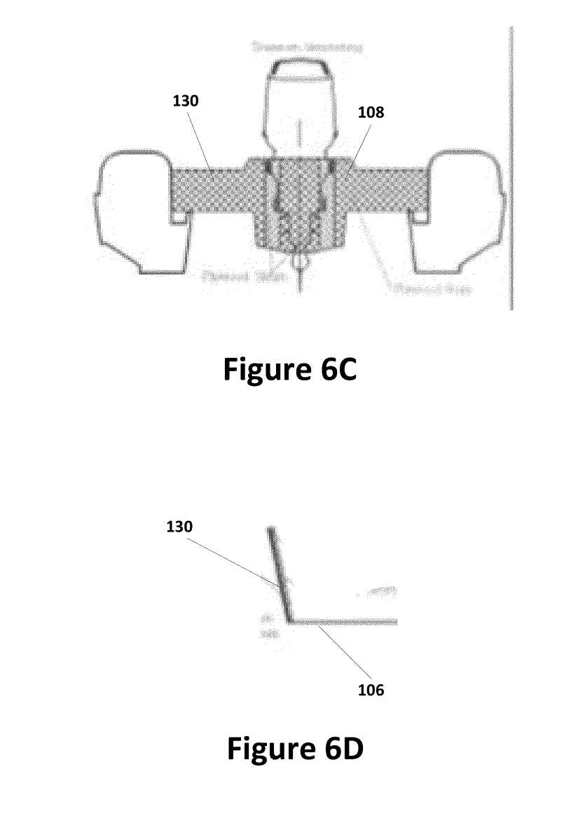

FIG. 6A shows the bonding of seat 114 to deck 106. As shown in FIG. 6A, seat 114 is glassed onto deck 106 at bond 602. The following lamination schedule can be utilized to form bond 602: CSM 300 and CSM 300.

Additionally, guides 402 shown in FIG. 4B can be formed with the following lamination schedule: FRP (2×70) covered by CSM 300 and CSM 300. Also, walls 204 shown in FIG. 5 can be formed by the following lamination schedule; FRP 3×70 covered by CSM 300 and CSM 300.

FIG. 6B illustrates a cross section of rescue boat 100 through mating mounts 124 and illustrates formation and bonding of center hull 112, pontoons 102 and 104, and the formation and reinforcement of mating mounts 124. Center hull 112 can be formed with the following lamination schedule: Gelcoat, CSM 300, CSM 300, E-BX600, CSM 300, and 8 mm Divinycell covered by CSM 300 and CSM 300. As shown in FIG. 6B, a reinforcement 604 can also be formed on deck 106 and positioned to engage pontoons 102 and 104. Reinforcement 604 can be formed by the following lamination schedule: 8 mm Divinycell covered by CSM 300 and CSM 300. Deck 106, then, can be formed by laminating the deck floor of deck 106, laminating the center hull, laminating seats 114, laminating platform 128, laminating transom 130, and bonding seats 114, platform 128, and center hull 112.

As is further shown in FIG. 6B, pontoons 102 and 104 include an upper portion 608 and a lower portion 606, which can be bonded together to form pontoons 102 and 104. Lower portion 606 can be formed with the following lamination schedule: Gelcoat, CSM 250, E-BXM 450/225, and CSM 250. Upper portion 608 can be formed with the following lamination schedule; Gelcoat, CSM 250, E-BXM 450/225, E-BXM 450/225, and CSM 250. Further, FIG. 6B illustrates further reinforcement 612 in mating mounts 124. Reinforcement 612 can be formed by the following lamination schedule: FRP 3 mm covered by CSM 300 and CSM 300. Center mount 112 can be bonded to deck 106 with bond 610. Bond 610 can be formed by forming a deck cover laminate and a bond. Deck cover laminate can be formed according to the following bonding schedule: Gelcoat, CSM 300, CSM 300, E-BX600, and CSM 300. The bond can be formed according to the following bonding schedule: CSM 300 and CSM 300.

As is further illustrated in FIG. 6B, skid 210 can include a wearable strip 610, for example of Teflon, inserted into a depression 614 formed in pontoon 104. Wearable strip 610 can be connected to a structural strip 616, for example with screws 612 through pontoon 104 and into strip 616. A box 618 can enclose strip 616. As an example that can be used in a rescue boat 100 with sizes illustrated in the above table, wearable strip 610 can have dimensions 60×12 mm and be of a length sufficient to cover a substantial portion of the bottom of pontoon 104. Structural strip 616 can be, for example, a Phenolic strip bonded onto depression 614 with the following bonding schedule: Phenolic strip, CSM 300, CSM 300. As an example, structural strip 616 can include a phenolic strip of dimensions 30×12 mm and have length to span wearable strip 610. Box 618 can be formed by FRP and have a bonding schedule: FRP, CSM 300, CSM 300. For example, the FRP utilized in box 618 can be 1×450 CSM and be 60×40 mm with length sufficient to cover structural strip 616. Screws 612 can be sized and placed sufficiently to hold wearable strip 610 onto pontoon 104.

As shown in FIG. 6B, a wearable strip 610 provides a surface that can be utilized to drag boat 100 over obstructions. Wearable strip 610 can be replaced as it wears away.

FIGS. 6C and 6D illustrate formation of transom 130. Transom 130 includes motor mount 108. Transom 130 can be formed by the following lamination schedule: Gelcoat, CSM 300, CSM 300, E-BX 600, CSM 300, 8 mm plywood, 18 mm plywood (to form motor mount 108), CSM 300, RW 600, and CSM 300.

The above example lamination schedules should not be considered to be limiting. One skilled in the art will recognize that other materials and schedules can be utilized to form rescue boat 100.

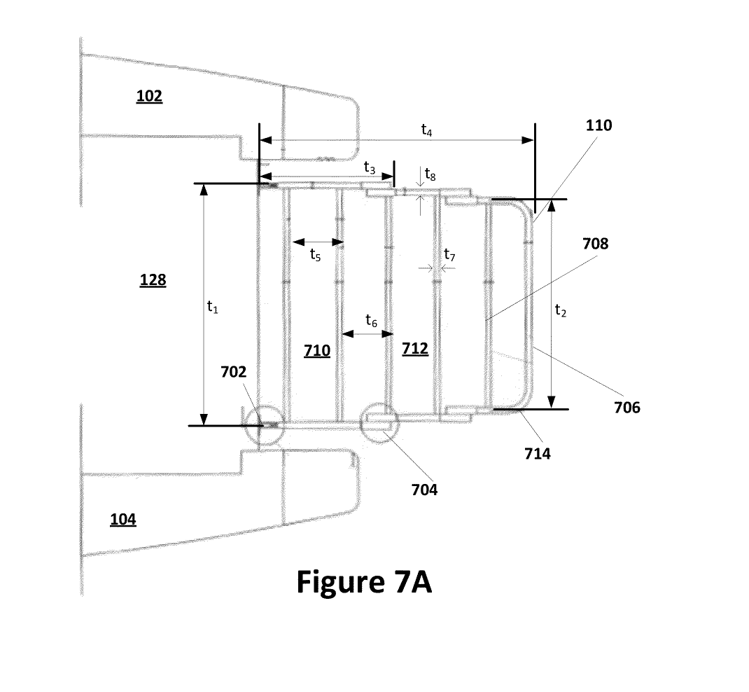

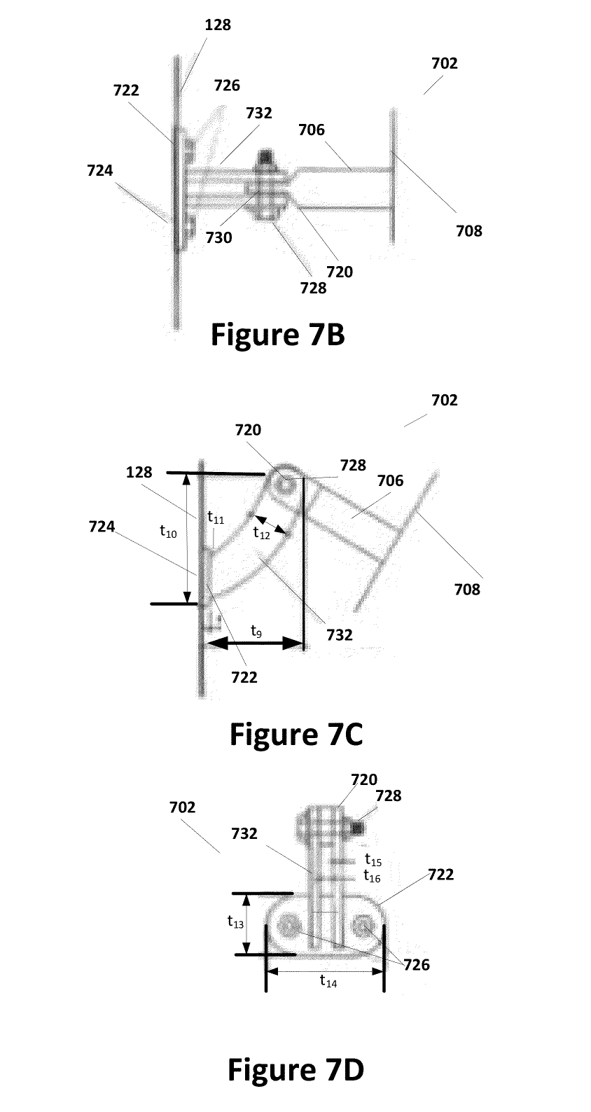

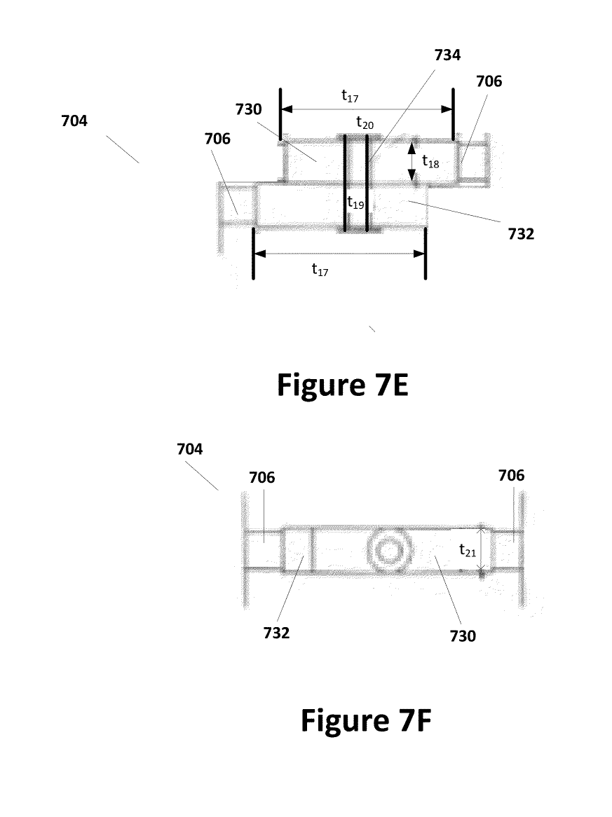

FIG. 7A illustrates an embodiment of rescue ramp 110. As shown in FIG. 7A, rescue ramp can be formed of tubing 706 and 708, for example aluminum tubing. Tubing 706 is utilized in an outside frame and has diameter t8. Tubing 708 forms cross struts and can have a diameter t₇. Generally, the diameter t8 can be greater than the diameter t₇. Tubing 708 and 706 can be bonded where they intersect, for example by welding. In some embodiments, netting can be strung between tubing 708 and 706 to assist in the loading of rescue victims.

Tubing 706 and 708 can be utilized to form multiple sections, of which sections 710, 712, and 714 are illustrated. Section 714 is the forward most section and tubing 706 can have rounded corners. Section 712 is joined with sections 710 and 714 at hinges 704. Hinges 704 allow sections 714, 712, and 710 to fold onto the top of each other for stowage on platform 128. A mount 702 joins section 710 to platform 128 and allows ramp 110 to be folded onto platform 128.

As shown in FIG. 7A, section 710 has a width of t1 while section 714 has a width of t₂. The distance between platform 128 and hinge 704 between section 710 and 712 is t₃. The distance between platform 128 and the outside edge of section 714 is t₄. The distance between the first and second ones of tubing 708 can be t₅ while the distance between the remaining tubing 708 is t₆.

FIG. 7B illustrates a view of mount 702 from the top. As shown in FIG. 7B, mount 702 includes a hinge 720 and a mounting plate 722. In some cases, platform 128 can include a reinforcement 724 at mounting plate 722. Reinforcement 724 can be formed of 3 mm FRP covered with CSM 300 and CSM 300. Mounting plate 722 can be attached to platform 128 at reinforcement 724 with bolts 726.

Hinge 720 can be formed by a bolt 728 through the end of ears 732, which are attached to plate 722. Ears 732 may, for example, be welded to plate 722. The end of tubing 706 may be flattened and captured between ears 732 by a bolt 728 through ears. Tubing 706 can then rotate around bolt 730.

FIG. 7C illustrates a side view of mount 702. As shown in FIG. 7C, ears 732 are a curved piece that are bonded to mount plate 722. The distance between platform 128 and the outer ends of hinge 720 is t₉. The distance between the bottom of mounting plate 722 and the outer end of hinge 720 is t₁₀. The thickness of mounting plate is t₁₁. Further, ears 732 have a width of t₁₂.

FIG. 7D shows a frontal view of mount 702. As shown in FIG. 7D, mounting plate 722 is t₁₃ high by t₁₄ wide. Further, ears 732 are formed of two plates with thickness t₁₅ separated by a distance of t₁₆. Mount 702 can be formed of any material, for example aluminum or stainless steel.

FIGS. 7E and 7F illustrate an embodiment of hinge 704. Hinge 704 can be formed from plates 730 and 732 rotatably coupled together by pin 734. Pin 734 can, for example, be a bolt, which may include washers, or a rivet. FIG. 7E illustrates a view from above while FIG. 7F provides a view from the side. As shown in FIG. 7E, tubing 706 is bonded, for example by welding, into plates 730 and 732. Plate 730 rotates on pin 734 with respect to plate 732.

As shown in FIG. 7E, plates 730 and 732 have a length of t₁₇ and a width of t₁₈. As shown in FIG. 7F, plates 730 and 732 have a height of t₂₁. As shown in FIG. 7E, pin 734 can include a bolt or rod with diameter t₁₉ and end pieces, for example washers, of diameter t₂₀.

Table 2 below provide example values for the dimensions of components of rescue platform 110 according to some embodiments. The dimensions provided in Table 2 can be appropriate for the dimension of rescue boat 100 illustrated in Table 1 above.

TABLE 2

| Designation | Measurement (mm) |
|---|---|
| t₁ | 960 |
| t₂ | 840 |
| t₃ | 530 |
| t₄ | 1100 |
| t₅ | 210 |
| t₆ | 200 |
| t₇ | 20 |
| t₈ | 25 |
| t₉ | 70 |
| t₁₀ | 100 |
| t₁₁ | 5 |
| t₁₂ | 35 |
| t₁₃ | 40 |
| t₁₄ | 80 |
| t₁₅ | 5 |
| t₁₆ | 10 |
| t₁₇ | 120 |
| t₁₈ | 30 |
| t₁₉ | 10 |
| t₂₀ | 30 |
| t₂₁ | 30 |

As illustrated above, some embodiment of rescue boat 100 can be a high performance rescue boat operable by a minimum number of rescue person, for example 2 people. Some embodiments of rescue boat 100, such as the particular example described above, can meet the highest safety standards. For example, some embodiments of rescue boat 100 can meet the requirements of the International Convention for the Safety of Life at Sea (SOLAS). One such test includes a drop test for rescue boat, where the prototype boats are dropped from 3 m, and then inspected for structural failures.

Utilizing the dimensions of the embodiment of rescue boat 100 provided in Tables 1 and 2 can provide for a rescue boat with a length of 4.4 m, beam of 2.2 m, height of 0.8 m, and unloaded draft of 0.22 m. Rescue boat 100 may have a draft of 0.50 m with a light load and 0.55 m with a heavier load. In embodiments where motor 202 is, for example, a 40 hp outboard engine, the embodiment of rescue boat 100 described above can reach speeds of 27.8 kns with a load of two people and speeds of 19.5 kns with a load of seven people.

Embodiments of rescue boat 100 according to the present invention can be unsinkable, virtually impossible to capsize because of pontoons 102 and 104, easily transportable by a minimum number of people, highly maneuverable, easily deployable, extremely durable, and easily stored. This combination of features exhibited by embodiments of rescue boat 100 can provide for fast rescues under extreme conditions.

The above detailed description is provided to illustrate specific embodiments of the present invention and is not intended to be limiting. Numerous variations and modifications within the scope of the present invention are possible. Rescue boats of larger or smaller dimension can be provided according to embodiments of the present invention. The present invention is set forth in the following claims.

What is claimed is:

1. A rescue boat, comprising:
a port pontoon;
a starboard pontoon; and
a deck, the deck being attachable to the port pontoon and the starboard pontoon.

2. The rescue boat of claim 1, wherein the deck includes
one or more seats;
a forward platform; and
a transom with a motor mount.

3. The rescue boat of claim 2, further including a rescue ramp attached to the forward platform.

4. The rescue boat of claim 1, wherein the deck is attached to the port pontoon and the starboard pontoon at mating mounts.

5. The rescue boat of claim 1, wherein the deck includes an integrally formed center hull.

6. The rescue boat of claim 1, wherein the deck includes guides that mate with insets integrally formed in the port pontoon and the starboard pontoon.

7. The rescue boat of claim 1, wherein the pontoons include a skid.

8. A method of a launching a rescue boat, comprising:
placing a port pontoon, a starboard pontoon, and a deck in proximity close to a launch point;
mating the deck with the port pontoon and the starboard pontoon;
attaching the deck with the port pontoon and the starboard pontoon;
mounting a motor on a motor mount on the deck; and
launching the rescue boat formed by the port pontoon, the deck, and the starboard pontoon.

9. The method of claim 8, wherein mating the deck with the port pontoon and the starboard pontoon by aligning guides formed on the deck to insets formed in the pontoons and coupling the deck with the port pontoon and the starboard pontoon.

10. The method of claim 8, wherein attaching the deck with the port pontoon and the starboard pontoon includes fastening the deck to the port pontoons and the starboard pontoons with fasteners.

11. The method of claim 10, wherein the fasteners are bolts.

12. A method of forming a rescue boat, comprising:
forming a port pontoon;
forming a starboard pontoon; and
forming a deck,
wherein the deck is capable of being removably attached to the port pontoon and the starboard pontoon.

13. The method of claim 12, wherein forming a port pontoon and forming a starboard pontoon includes
laminating a lower hull section;
laminating an upper hull section;
bonding supports; and
bonding the lower hull section to the upper section.

14. The method of claim 13, wherein forming the deck includes
laminating the deck;
laminating a center hull;
laminating seats
laminating a platform;
laminating a transom integrally with the deck; and
bonding the seats, the platform, and the center hull to the deck.

15. The method of claim 13, further including forming a skid on the port pontoon and the starboard pontoon.

16. The method of claim 15, wherein forming the skid includes
providing a structural strip within the pontoon; and
screwing a wearable strip through the pontoon and into the structural strip.
